(19) United States
(12) Patent Application Publication
(10) Pub. No.: US 2025/0117314 A1
(43) Pub. Date: Apr. 10, 2025

(54) SOFTWARE TEST RESULT AGGREGATION FRAMEWORK

(71) Applicant: SAP SE, Walldorf (DE)

(72) Inventor: Ashish Kumar, Patna (IN)

(73) Assignee: SAP SE, Walldorf (DE)

(21) Appl. No.: 18/377,739

(22) Filed: Oct. 6, 2023

(51) Int. Cl. G06F 11/36

(52) U.S. Cl. CPC G06F 11/3692; G06F 11/3698

(57) ABSTRACT

The present disclosure provides techniques and solutions for retrieving and presenting test analysis results. A central testing program includes connectors for connecting to one or more test management systems. Test data, such as test results in test logs, is retrieved from the one or more test management systems. For failed tests, failure reasons are extracted from the test data. Test results are presented to a user in a user interface, including presenting failure reasons. A link to a test log can also be provided. A user interface can provide functionality for causing a test to be reexecuted.

### FIELD

The present disclosure generally relates to software testing.

### BACKGROUND

Software programs can be exceedingly complex. In particular, enterprise level software applications can provide a wide range of functionality, and can process huge amounts of data, including in different formats. Functionality of different software applications can be considered to be organized into different software modules. Different software modules may interact, and a given software module may have a variety of features that interact, including with features of other software modules. A collection of software modules can form a package, and a software program can be formed from one or more packages.

Given the scope of code associated with a software application, including in modules or packages, software testing can be exceedingly complex, given that it can include user interface features and “backend” features and interactions therebetween, interactions with various data sources, and interactions between particular software modules. It is not uncommon for software that implements tests to require substantially more code than the software that is tested.

Software testing for software development and maintenance typically is relatively “compartmentalized.” For example, some packages, or package modules, can be tested in different platforms, and different testing platforms may need to be used in order to execute tests and analyze test results. Even within a single software testing platform, tests are often split according to software organizational units, such as functions or modules. It can be difficult for a software developer to analyze test results, such as to determine appropriate action to be taken, such as re-running a test or performing updates to test code or tested code to address test failure. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques and solutions for retrieving and presenting test analysis results. A central testing program includes connectors for connecting to one or more test management systems. Test data, such as test results in test logs, is retrieved from the one or more test management systems. For failed tests, failure reasons are extracted from the test data. Test results are presented to a user in a user interface, including presenting failure reasons. A link to a test log can also be provided. A user interface can provide functionality for causing a test to be reexecuted.

In one aspect, the present disclosure provides a process for retrieving and displaying test results. A first definition is received of a first software test plan that includes a first plurality of test cases executed at a first test management system. Using a first connector, a connection is made to the first test management system. A first plurality of test logs are retrieved, corresponding to test results of execution instances of at least a portion of the first plurality of test cases. The first plurality of test logs are parsed to identity a first set of failure reasons, the first plurality of test logs being in a first format.

At least a portion of the test results of the execution instances of the at least a portion of the first plurality of test cases are displayed on a user interface. For one or more test results associated with at least one failure reason of the first set of failure reasons, the displaying on a user interface includes displaying an identifier of a respective test case and displaying a respective at least one failure reason.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIG. 1 is a diagram of a computing environment in which disclosed techniques can be implemented, where a test analysis framework is in communication with a plurality of testing platforms.

FIG. 2 is an example user interface screen illustrating software testing tasks, including how tasks can be associated with one or more test plans.

FIG. 3 is an example user interface screen providing information associated with various test plans of a test.

FIG. 4 is an example user interface screen illustrating how test plans can include multiple test cases, and execution information for test cases can provide a link to log information for an execution instance of a test case and, where test case execution failed, a failure reason.

FIGS. 5A and 5B illustrate example test log formats.

FIGS. 6A-6D provide example test logs, including illustrating how test logs can be in different formats, and thus may involve different log parsing logic.

FIGS. 7A and 7B provide example code for retrieving and parsing test log data from a test management system.

FIGS. 8 is a flowchart of a disclosed process for retrieving and displaying test results.

FIG. 9 is a diagram of an example computing system in which some described embodiments can be implemented.

FIG. 10 is an example cloud computing environment that can be used in conjunction with the technologies described herein.

### DETAILED DESCRIPTION

### Example 1

### Overview

Software programs can be exceedingly complex. In particular, enterprise level software applications can provide a wide range of functionality, and can process huge amounts of data, including in different formats. Functionality of different software applications can be considered to be organized into different software modules. Different software modules may interact, and a given software module may have a variety of features that interact, including with features of other software modules. A collection of software modules can form a package, and a software program can be formed from one or more packages.

Given the scope of code associated with a software application, including in modules or packages, software testing can be exceedingly complex, given that it can include user interface features and “backend” features and interactions therebetween, interactions with various data sources, and interactions between particular software modules. It is not uncommon for software that implements tests to require substantially more code than the software that is tested.

Software testing for software development and maintenance typically is relatively “compartmentalized.” For example, some packages, or package modules, can be tested in different platforms, and different testing platforms may need to be used in order to execute tests and analyze test results. Even within a single software testing platform, tests are often split according to software organizational units, such as functions or modules. It can be difficult for a software developer to analyze test results, such as to determine appropriate action to be taken, such as re-running a test or performing updates to test code or tested code to address test failure. Accordingly, room for improvement exists.

The present disclosure provides techniques that can retrieve and display test results from multiple test platforms. For example, a central test analysis program can include adapters to retrieve test results from different test platforms. Thus, rather than having to login to multiple test platforms to get test results of interest, a user can simply access the central test analysis program.

The central test analysis program can provide other advantages, such as providing access to one or more test logs associated with execution of a particular test. The central test analysis program can also provide reasons why a test failed, which can save both user time and computing resources as compared with prior techniques where, for example, a user may have to manually load and review a test log to determine a failure reason.

Disclosed techniques can also facilitate taking action in response to test failure. For example, a user may select to manually re-execute a test, or to trigger automatic re-execution of a task. The action can be taken from the central test analysis program, which can save user time and computing resources compared with a scenario where a user would need to access another program to initiate test reexecution.

Thus, disclosed techniques can benefit users by providing them with a holistic view of tests, including test results for a variety of software applications and components thereof, where the test results may be performed by multiple testing platforms. However, the disclosed techniques also reduce computing resource use, since a user no longer needs to engage in individual processes (such as UI interactions) to retrieve individual test results.

### Example 2

### Example Test Analysis Computing Environment

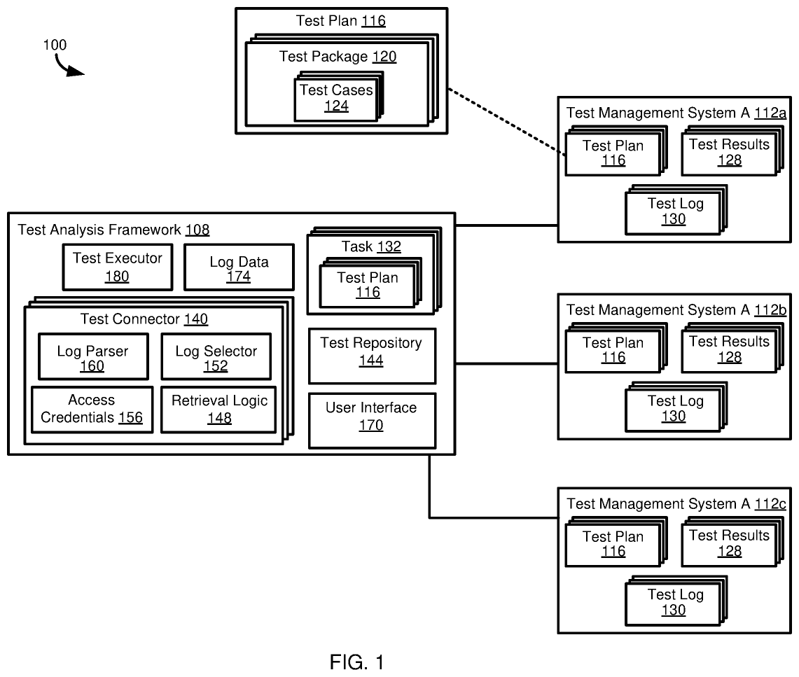

FIG. 1 illustrates an example computing environment 100 in which disclosed techniques can be implemented. The computing environment 100 includes a test analysis framework 108 that is in communication with one or more test management systems 112 (shown as test management systems 112a-112c.). The test analysis framework 108 can be a program that is accessible by a user, or the test analysis framework can be embedded in, or accessible through, another program.

Particular implementations have the testing framework 108 be in communication with multiple test management systems 112, where at least a portion of these test management systems differ in what programs are tested by a given test management system, what kind of tests are performed, how tests are performed (such as being performed manually or being automated) how tests are implemented, and how test results are reported or stored, such as a log format.

As shown, the test management systems 112 includes one or more test plans 116. As used herein, a “test plan” refers to a high-level grouping of test functionality, such as for testing a variety of modules/functionalities of a software application. The test plans 116 include one or more test packages 120, where the test packages test a specific module/functionality. In turn, each test package 120 can include one or more test cases 124, where the test cases are specific tests (or a combination of a specific test and specific data to be used during a test) that are executed to provide test results 128. All or a portion of the test results 128 can be stored, such as in one or more test logs 130.

However, the disclosed techniques are not limited to these specific test groupings. That is, tests can be grouped in a variety of ways, including grouping at multiple levels (such as having multiple intermediate groups of different collections of tests, where at least a portion of those intermediate groups are grouped at a yet higher level). Further, at least certain aspects of the present disclosure can provide benefits with respect to test cases 124, regardless of whether the test cases have been grouped.

The testing framework 108 illustrates how tasks 132 can be defined with respect to one or more test plans 116. However, tasks 132 can be defined in other ways, such as with respect to test packages 120 or individual test cases 124. In some cases, a task 132 can represent responsibilities of a particular user, such as a developer. That is, the developer may be charged with developing particular software associated with a test case 124, or for maintaining operational integrity of such software.

The test analysis framework 108 can include one or more test connectors 140. Typically, a test connector 140 is defined for each different type of test management system 112. That is, at least in some cases, a given test connector 140 can be used for multiple test management systems of the same type. Generally, a test connector 140 retrieves and processes test results 128 from a test management system 112, including by accessing the test logs 130.

The test connector 140 can also store information regarding test plans 116, including packages 120 and test cases 124, such as in a test repository 144. In some implementations, the test repository 144 stores metadata about test plans 116, test packages 120, or test cases 124, such as information regarding the associated test management system 112, as well as storing grouping information or information about users associated with various test plans or components thereof, but does not store executable information for test cases 124. In other implementations, the test repository 144 stores executable information, such as test definitions, for test cases 124. Even if the test repository 144 does not store executable information for test cases 124, the test analysis framework 108 can allow a user to retrieve such information from a test management system 112, or to cause test cases to be executed (including by selecting a particular test package 120 or test plan 116 for execution) or to cause execution of a test case at a test management system.

A given test connector 140 can include retrieval logic 148. The retrieval logic 148 is programmed to access data, such as the test results 128 or test logs 130, in a given test management system 112. The retrieval logic 148 can also be used, in at least some cases, to obtain information about test plans 116, test packages 120, or test cases 124 of a test management system 112, such as for use in populating the test repository 144, or to cause execution (such as reexecution) of one or more test cases at a test management system.

In some cases, as will be further described, multiple logs 130 for a particular test case 124 may exist at a test management system. For example, a test case 124 may have been executed multiple times over a time period. In at least some cases, the test analysis framework 108 may retrieve and process test information from test management systems 112 at particular intervals. For example, the test connectors 140 may be configured to retrieve test logs 130 after the close of a particular business day, and have the results ready at the beginning of the following business day. The retrieval logic 148 can use a log selector 152 to retrieve test logs 130 that occurred during a current analysis interval, rather than retrieving older test logs.

Even during a particular interval, there can be multiple test logs 130, including for particular executions of a given test case 124. In some cases, the retrieval logic 148 can retrieve all logs 130, while in other cases, the retrieval logic can be configured to retrieve a subset of logs in an interval, including retrieving a single log, using the log selector 152.

Various criteria can be used to determine what log 130 or logs should be selected. For example, the log selector 152 can be configured to cause the retrieval logic 148 to retrieve a most recently executed log 130. Or, the log selector 152 can be configured to cause the retrieval logic 148 to retrieve any logs 130 that include a failure result. That is, some software issues can be intermittent, and so a developer may wish to be aware of any test executions that failed, even if a later or last test execution succeeded/completed without errors. Different test management systems 112 can maintain their logs 130 in different ways, both in terms of log naming and log contents, and so the log selector 152 can be customized for a given test management system, including providing suitable information to the retrieval logic 148 for identifying and retrieving appropriate logs.

In accessing the test management systems 112, the test connectors 140 can use access credentials 156, such as username and password information, to obtain test logs 130 to which a particular user has access. In some cases, it may be desirable to retrieve all logs 130 from test management systems 112. Users of the test analysis framework 108 can have access to all test logs 130, in some cases, while in other cases restrictions can be applied, where users only see relevant logs/logs to which they have access permissions, but the permissions can be enforced at the test analysis framework 108, rather than at the test management systems 112. Further, maintaining and using access restrictions for individual users can require significant amounts of storage or processor use. Therefore, in some cases, the access credentials 156 can provide “superuser” access to the test management systems 112, so that all test logs 130 can be accessed using the same credentials, including retrieving logs that would otherwise be associated with different access credentials in a single request.

As will be further described, the test analysis framework 108 can analyze logs 130, including to provide users with more information than is typical in testing systems. This information can be obtained using a log parser 160. Like the retrieval logic 148 and the log selector 152, the log parser 160 of a given test connector 140 can be specifically programmed to parse a particular format for test logs 130 used by a test management system 112. For example, different log formats can report errors in different ways, such as using different error codes or different test messages, and the tokens indicating errors and error reasons can differ.

The test analysis framework 108 can include one or more user interfaces 170 that allow users to view information about particular tasks 132, test plans 116, test packages 120, test cases 124, test results 128 or test logs 130, or information extracted from such information, such as information extracted by the log parser 160. As will be described, in some cases a user interface 170 can allow a user to navigate from more general information, such as tasks 132, to more granular information, such as execution results of test cases 124, including information regarding such execution results extracted by the log parser 160 of the appropriate test connector 140.

In at least some cases, at least a portion of log data 174 for test logs 130 is stored at the test analysis framework 108. In some cases, data of the log data 174 can correspond to data to be provided through a user interface 170. However, in other cases, additional data can be stored, such as all or a portion of log entries in the test logs 130 that are not associated with failures.

In some implementations, the log parser 160, instead of, or in addition to, parsing data from the test logs 130 at the test management systems 112, can parse the log data 174. In a particular example, log data is retrieved for test logs 130 of a test management system 112 using a test connector 140, such as one that obtains log data for test logs 130 satisfying different filter conditions. This log data can be parsed by the log parser 160, such as to extract portions of the log data or to format the log/test result data. In particular, the log parser 160 can convert log data from a first format, such as JSON, to a second format, such as SQL. In a particular implementation, at least a portion of the log data 174 is stored in a relational format, and the log parser 160 can include logic to query the log data in the relational format, such as in response to commands to generate a user interface 170.

When test cases have failed, particularly when they failed, or even failed to run, such as because particular resources were not available, disclosed techniques allow a user to request reexecution of a test case (either a test case 124, or a set of test cases as part of a request to re-execute a test package 120 or a test plan 116). For example, a user interface 170 can allow a user to call a test executor 180, which either executes the appropriate test cases 124 or causes such test cases to be executed, such as by communicating with a test management system 112. In particular example, test case execution can be facilitated using technologies such as SELENIUM (Software Freedom Conservancy) or START (SAP SE).

### Example 3

### Example User Interfaces for Viewing Test Results

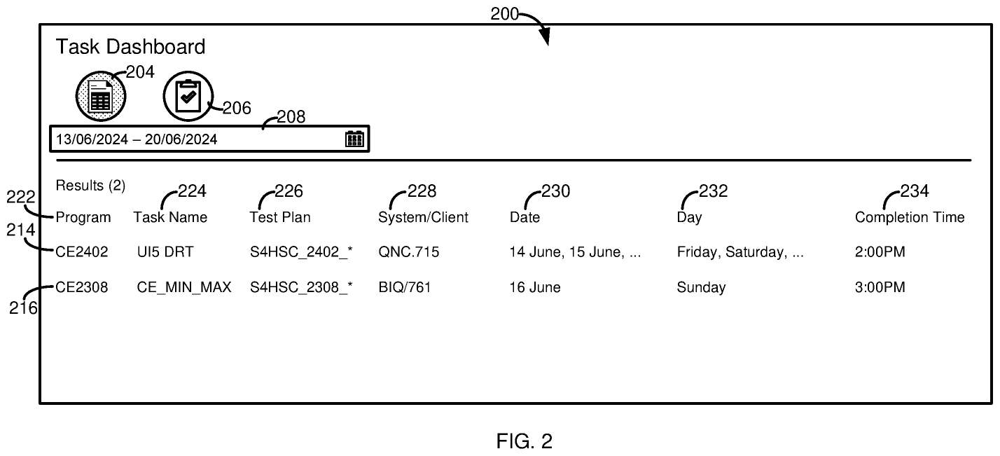

FIGS. 2-4 illustrate example user interfaces that a user can interact with to obtain information regarding test results. The user interfaces can correspond to user interfaces 170 of FIG. 1.

FIG. 2 illustrates a user interface 200 that presents a user with tasks for which they are responsible. In some implementations, the user interface 200 can represent an initial user interface that is presented to a user, providing more general information organized as tasks, where a user can then select a particular task to “drill down” to greater levels of granularity, such as selecting test plans, test packages, or test cases associated with a particular task.

In the user interface 200, a user can select to view tasks by a particular time period, such as choosing to view weekly tasks, by selecting a user interface control 204, or daily tasks, by selecting a user interface control 206. The user interface 200 is shown with the user interface control 204 selected, and a control 208 displays a particular time period (such as a calendar week) for displayed tasks. A user can optionally change the time period associated with the control, such as selecting a different calendar week.

The example user interface 200 illustrates tasks 214, 216 as satisfying the criteria of weekly tasks within the time period defined in the control 208. Values for a variety of attributes can be provided for the tasks 214, 216. In particular, the user interface 200 illustrates each task 214, 216 including a program name 222, a task name 224, one or more test plans 226 for a given task (where the asterisk indicates additional test plans that exceed the length of a field for the test plans), a system/client 228 on which the test plan is executed, a date or schedule 230 where tests in the task are executed/the task is due, days of the week 232 corresponding to the schedule 230, and times 234 at which the task was completed. That is, for example, a result 214, 216 can indicate a task that corresponds to processing test execution results of tests executed in an instance of the task, at the completion times 234.

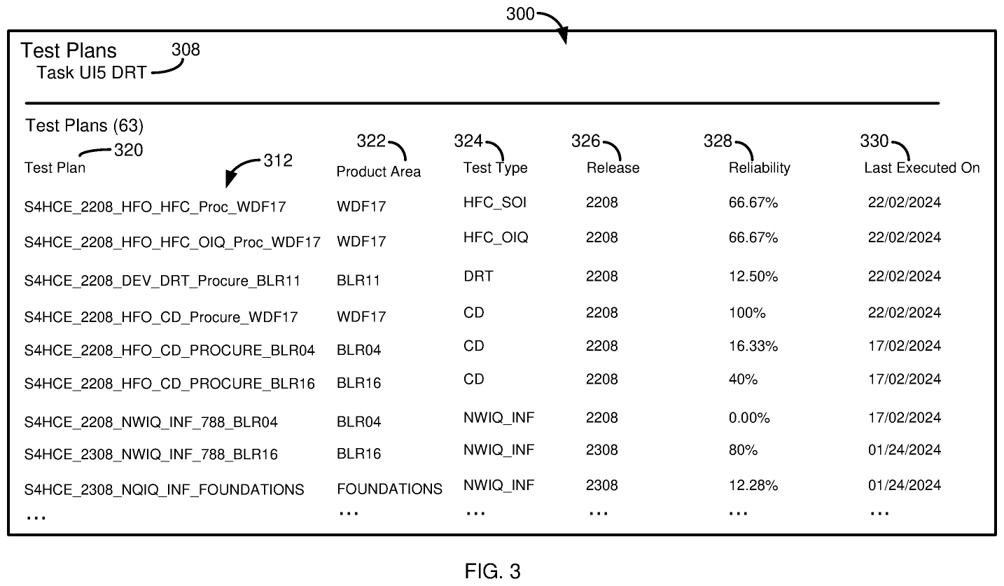

FIG. 3 provides an example user interface 300 that displays information for test plans. In a specific implementation, a user can navigate to the user interface 300 from the user interface 200 by selecting one of the tasks 214, 216, such as by selecting the corresponding value for the task name 224.

The user interface screen 300 displays an identifier 308 of the task associated with the displayed information. In this case, the identifier 308 identifies the task 214. The user interface screen 300 displays test plans 312 that are included in the task 214. Information for a given test plan 312 of a task associated with a given instance of the user interface screen 300 can include a name or identifier 320 of the test plan, an identifier of a product area 322 tested by the test plan, a type of test 324 associated with the given test plan, a release (such as a version) 326 of the tested software that was tested by an execution of tests in a given test plan, an overall indicator 328 of the reliability of the code tested by the test plan (which can be determined in various ways, such as percentage of successful tests in the test plan, or a percentage of code tested by tests of the test plan that was not associated with an error/test failure), and a date 330 on which the test plan was last executed (and which execution is summarized by the reliability indicator 328).

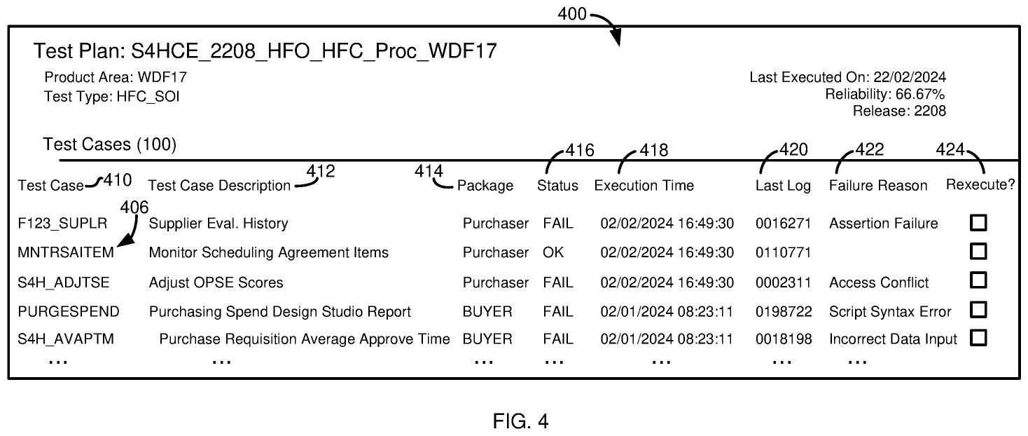

FIG. 4 illustrates a user interface 400 that displays test execution results, such as for a test plan 312 of the user interface 300. In an example, a user can navigate to the user interface 400 by selecting one of the test plans 312 in the user interface 300.

The user interface 400 lists test cases 406 in the selected test plan 312. For each test case 406, the user interface 400 can provide a name/identifier 410, a test case description 412, a package 414 within which the test case (or tested functionality) is organized, a status 416 of a last execution of the test (such as whether the test completed successfully, completed with errors, or was unable to complete for reasons other than a test error, such as if the resources needed to execute a test were not available), a last execution time 418, a log identifier 420 for a log associated with the last execution instance of the test case, and, if an execution of a test case failed, a failure reason 422.

In some cases, the log identifiers 420 can be linked to the identified log, so that a user can select a log identifier and be provided with the corresponding log. In the computing environment 100 of FIG. 1, the log can be stored on, or provided by, the test analysis framework 108, or the log can be stored on, or provided by (including loading a user interface of) a test management system 112.

Note that, typically the failure reasons 422 are not provided by test management systems, or systems that summarize information about multiple test management systems. That is, typically a user must manually select, open, and a review a log for a failed test execution to determine a failure reason. In addition, many testing platforms organize test information such that a user must expand test plans and test packages to see individual test cases and their corresponding logs. In contrast, the user interface 400 displays test cases and log identifications/links 420 without the need for such manual expansion. In addition to saving users significant amounts of time, significant computing resources are saved due to the reduced number of user interactions with a user interface.

Although a single failure reason 422 is shown in the user interface 400, in other implementations multiple failure reasons can be provided. That is, in some cases, a test may fail, in the sense of producing errors or unexpected results, without causing the test execution to terminate. So, test execution may continue, and additional errors/failure may be recorded. When a single failure reason 422 is shown, but multiple failures have occurred, a failure reason to be displayed can be selected using a variety of criteria. For example, a last observed failure reason can be displayed. If there were multiple failures, but one failure caused the test to terminate, the failure that caused test termination can be displayed. In other implementations, test failure reasons can be associated with different priorities/severities, and so a highest priority/severity failure reason can be displayed on the user interface 400.

The user interface 400 can also provide controls 424 that allow a user to select particular test cases 406 to be reexecuted.

### Example 4

### Example Test Log Formats

As discussed, tests can fail for a variety of reasons, and disclosed techniques can extract failure reasons from a log for provision to a user, which can save a user from manually retrieving and reviewing a log to determine a cause of test failure.

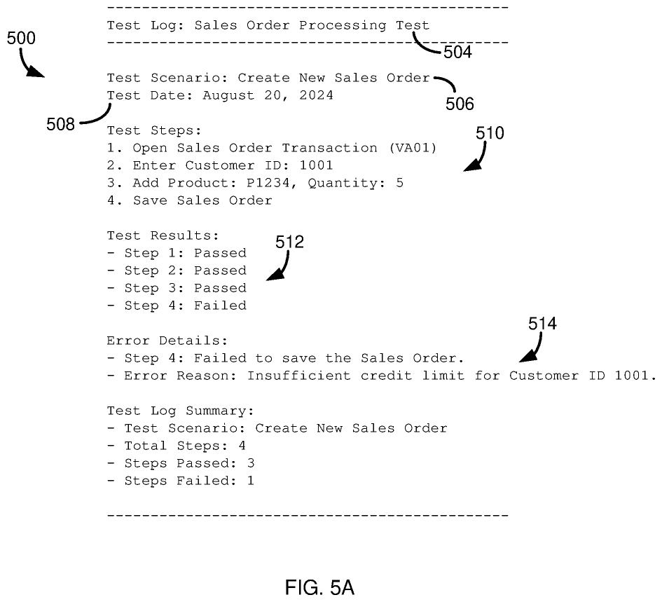

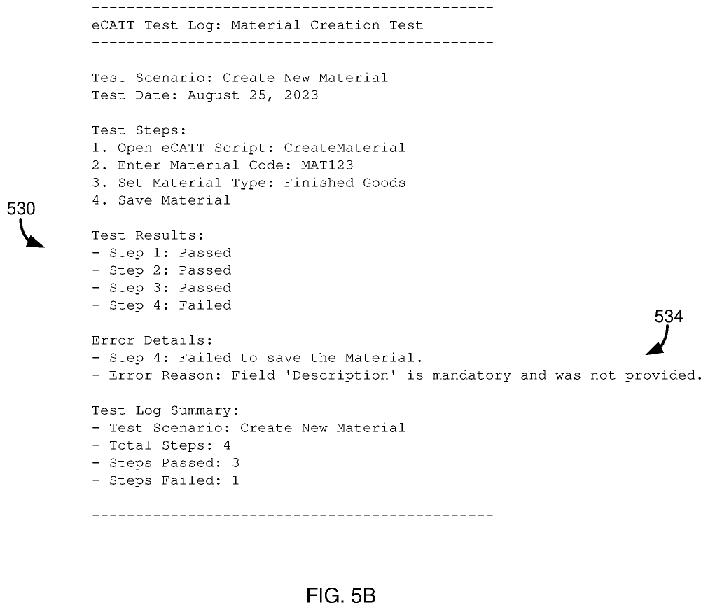

FIGS. 5A and 5B provide particular examples of test logs, including how test logs can identify various failure reasons. The test logs in FIGS. 5A and 5B can represent simplified examples of test logs that may be produced using various testing functionalities available from SAP SE, of Walldorf, Germany.

FIG. 5A illustrates a test log 500. The test log 500 includes a test name/test case 504 for which the log was generated, a description 506 of a scenario represented by the test, and a date 508 the test was executed to produce the test log 500. The test log 500 includes various steps 510 that are included in the test, as status results 512 for each step. In this example, it can be seen that Steps 1-3 passed, while Step 4 failed.

The test log 500, in addition to providing an indication in the status results 512 that Step 4 failed, provides specific error details 514. In this case, the error details 514 indicate that a data object (an instance of sales order) to be created by the test functionality could not be saved, in this case because a particular customer used for the sales order had an insufficient credit limit. A developer could then use this information to determine whether the test failed, for example, because of an error in calculating or retrieving a credit limit for a customer for a sales order, or that the data used for test execution was erroneous. In some cases, a test can be configured to confirm that software should fail to perform certain operations under certain circumstances.

FIG. 5B illustrates a test log 530 that is generally similar to the test log 500. In this case, error details 534 indicate that a test again failed to save a data object, in this case a new material, because a value was not provided for a mandatory field.

The logs 500, 530 are provided as simple examples to demonstrate log formats, including how logs can be parsed to obtain error information. For example, if a log format is known to use tokens “Error Details” and “Error Reason,” a log can be searched for these tokens and the information provided after the tokens extracted as failure information.

Further examples of test failure reasons include (where ECC and eCATT refer to testing environments provided by SAP SE, of Walldorf, Germany):
Test Failed, Reason: Incorrect Data Mapping: Data mapping between different modules or fields is incorrect, leading to data inconsistencies and incorrect results.
Test Failed, Reason: Integration Issue: Integration between ECC and an external system is not functioning as expected, causing data synchronization problems.
Test Failed, Reason: Custom Code Error: Custom-developed code contains bugs or logic errors, resulting in incorrect processing or system crashes.
Test Failed, Reason: Performance Bottleneck: The system experiences performance issues, such as slow response times or high resource consumption, impacting user experience.
Test Failed, Reason: Authorization Failure: Users do not have the correct permissions to access certain functionalities or data, leading to authorization failures.
Test Failed, Reason: Data Corruption: Test data or master data becomes corrupted, causing unexpected errors during processing.
Test Failed, Reason: Configuration Mistake: Incorrect system configuration settings lead to unexpected behavior or failures in specific scenarios.
Test Failed, Reason: Boundary Condition Issue: The system does not handle boundary conditions correctly, resulting in errors when specific limits are reached.
Test Failed, Reason: Data Migration Error: During data migration, data does not map properly to the new structure, leading to incorrect data in the system.
Test Failed, Reason: UI Bug: User interface elements do not function as intended or display incorrect information.
Test Failed, Reason: Patch or Update Issue: Applying patches or updates introduces unintended side effects that result in test failures.
Test Failed, Reason: Concurrent Access Conflict: Multiple users accessing the same data simultaneously result in conflicts or data inconsistencies.
Test Failed, Reason: Regression Issue: Changes introduced to fix one issue inadvertently cause new issues in other parts of the system.
Test Failed, Reason: Third-Party Integration Problem: Integration with a third-party system encounters issues, such as incompatible data formats.
Test Failed, Reason: System Resource Exhaustion: The system runs out of memory, disk space, or other resources, causing failures or crashes.
Test Failed, Reason: Incorrect Data Input: Test data provided to eCATT contains errors or inconsistencies, leading to unexpected behavior or outcomes.
Test Failed, Reason: Assertion Failure: Assertions defined in the eCATT script to validate expected outcomes are not met, indicating a deviation from the expected results.
Test Failed, Reason: Script Syntax Error: The eCATT script contains syntax errors or scripting mistakes, causing the script to fail during execution.
Test Failed, Reason: Data Migration Issue: When testing data migration scenarios, data does not migrate accurately or does not match the expected result.
Test Failed, Reason: Application Logic Bug: Bugs in the SAP application logic lead to incorrect processing, resulting in test failures.
Test Failed, Reason: Unhandled Exception: An unexpected error or exception occurs during the test script execution, causing the test to fail.
Test Failed, Reason: Test Environment Setup Error: The test environment is not properly configured, leading to incorrect execution of test scenarios.
Test Failed, Reason: External Dependency Issue: External systems or services that the test script interacts with encounter errors or downtime.
Test Failed, Reason: Data Corruption: Test data or master data used in the eCATT test becomes corrupted or altered, affecting test results.
Test Failed, Reason: UI Interaction Problem: If the eCATT script interacts with the user interface, issues such as incorrect UI element identification can lead to test failures.
Test Failed, Reason: Test Data Limitations: Inadequate or insufficient test data provided for certain scenarios can result in test failures.
Test Failed, Reason: Incorrect Configuration: Configuration settings within the eCATT script or the SAP system are incorrect, causing unexpected behavior.
Test Failed, Reason: Interactions with Previous Tests: Earlier test script executions might have introduced changes that impact the current test, causing failures.
Test Failed, Reason: Security Constraints: Access permissions or security settings restrict the execution of certain eCATT actions, leading to test failures.
Test Failed, Reason: Timing and Synchronization Issues: In scenarios where timing matters, synchronization issues can lead to unexpected outcomes and test failures.

Again, a log can be parsed to identify a location of a test failure reason, and the failure reason extracted and provided in a user interface 170 of the test analysis framework 108 of FIG. 1.

### Example 5

### Example Considerations in Parsing Test Logs of Different Formats

As discussed with respect to FIG. 1, test logs 130 of different test management systems 112 can have different formats, where different test connectors 140 can be defined to account for such differences. Differences in log formats can result from a variety of factors, including:
Non-Standardized Log Formats: In certain testing scenarios, different teams might use their own custom log formats. For instance, one team might use a log format that includes error messages within a dedicated “error” section rather than a standard “failure reason” field. Parsing such logs would require identifying the custom error section and extracting relevant information.
Localized Logs: Logs generated in different languages might display the “failure reason” equivalent in different languages. For example, “failure reason” could be translated as “Fehlergrund” in German logs. Adapting the parsing logic to identify translated terms would be necessary.
Complex Error Descriptions: Some logs might include multiline error descriptions or additional details. For instance, instead of a single “failure reason” field, a log might have a more detailed error traceback that spans multiple lines and requires more advanced parsing techniques.
Custom Error Handling: Certain testing scenarios might involve custom error handling, where error messages are generated and presented in a way that does not adhere to a standardized field. Extracting failure reasons in such cases might require parsing error messages in specific sections of the log.
Contextual Error Information: Instead of a distinct “failure reason” field, logs might provide contextual information about errors. For example, a log might describe the error within a narrative, requiring more complex text analysis to identify and extract failure reasons.
Variation in Terminology: Testing logs might use variations of terms. For instance, instead of “failure reason,” a log might use “error cause” or “issue description.” Adjusting the parsing logic to account for such variations would be necessary.

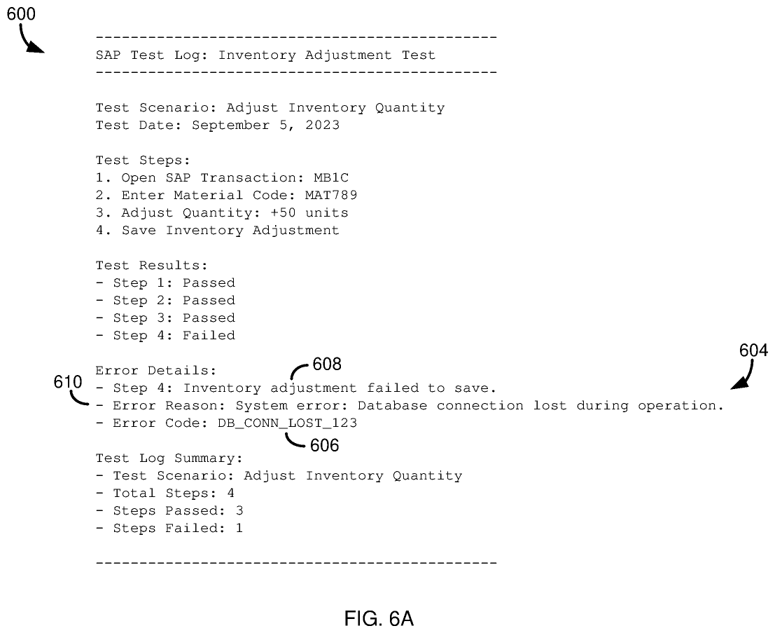

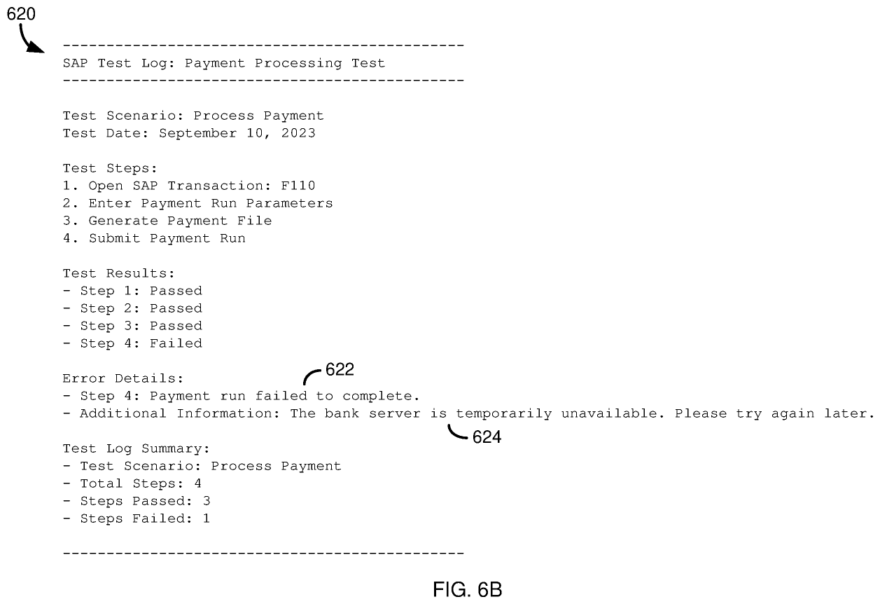

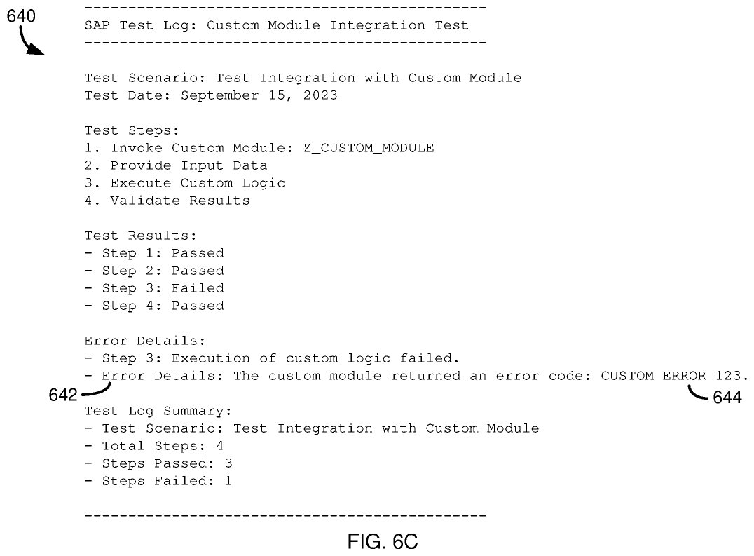

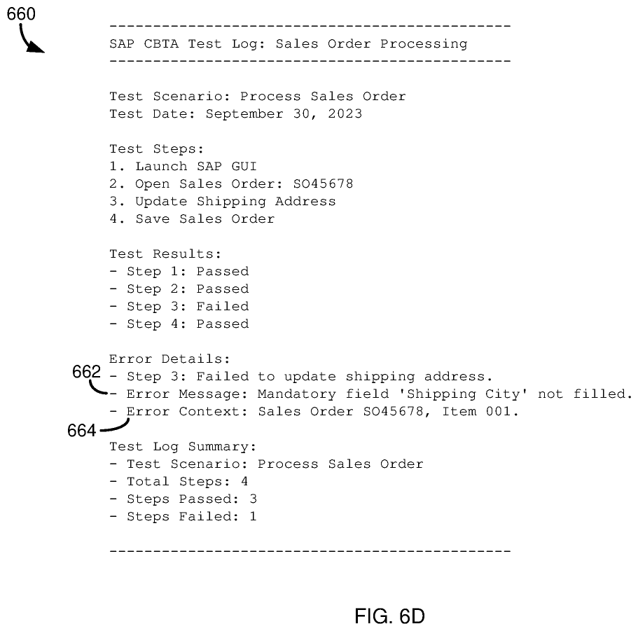

FIGS. 6A-6D provide example logs illustrating particular sources of log complexity that may make it difficult to use the same type of log parsing with different test management systems. In particular, a log 600 of FIG. 6A illustrates how complex error descriptions can affect log parsing. That is, the error description 604 spans multiple lines of the log, and includes an error code 606, as well as a more general description 608 of the error and an error reason 610. Further, in some cases it may be desirable to report a more human-understandable description of the error indicated by the error code, and a log parser can perform such actions (that is, replacing an error code with a more human-understandable description).

A log 620 of FIG. 6B provides an example of a log that contains contextual error information. That is, rather than providing an explicit “error reason,” the log 620 includes a general summary 622 of the error and then provides contextual information 624, in this case indicating that a particular server needed to complete an operation was not available. Thus, parsing the log 620 to look for a use of “Error Reason” would not retrieve the contextual information 624.

FIG. 6C provides a log 640 that employes custom error handling logic and code. That is, error details 642 indicated an error code 644. In some cases, logic for parsing the log 640 would need to account for such custom error codes, such as having definitions of custom error codes available, or being programmed to recognize, for example, a naming convention used for custom error codes.

FIG. 6D illustrates another log 660 having a somewhat different error reporting format, in this case having an “Error Message” 662 and an “Error Context” 664.

### Example 6

### Example Code for Retrieving and Parsing Test Logs

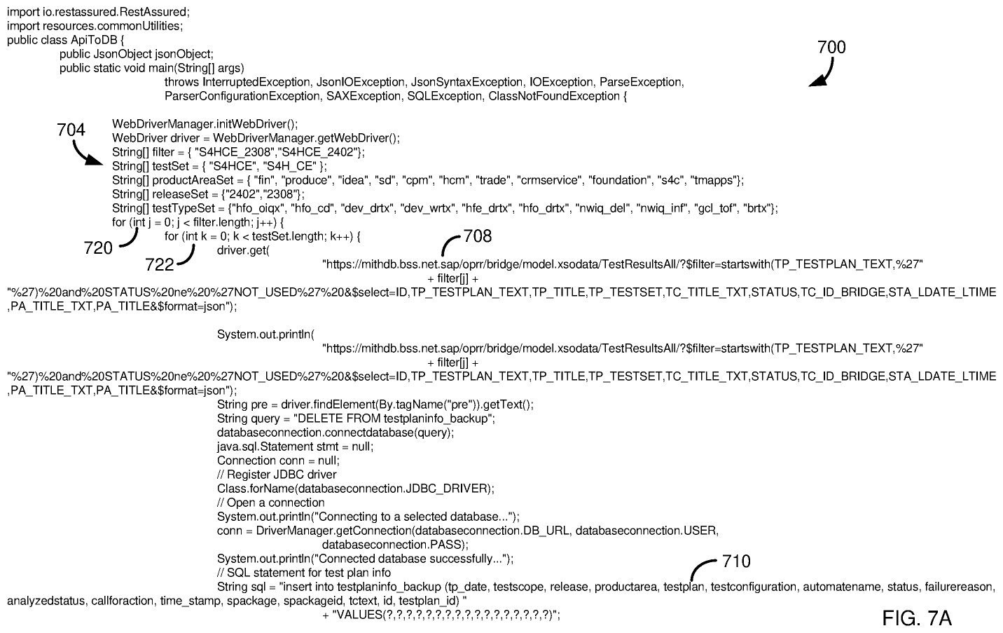

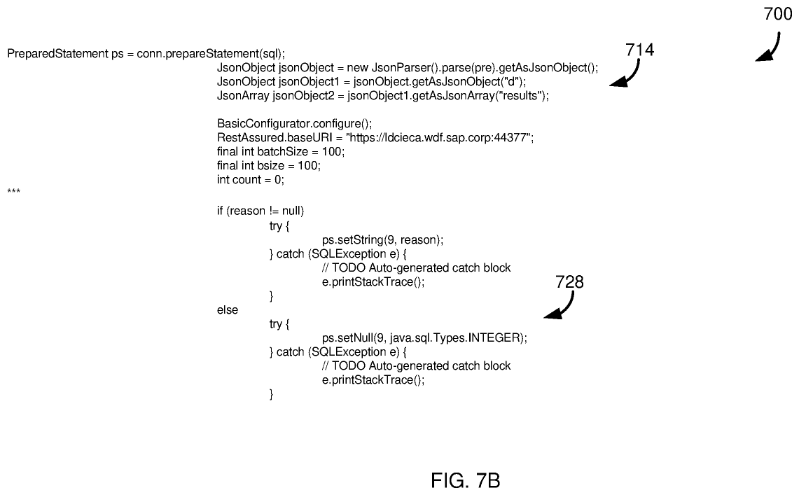

FIGS. 7A and 7B provide example code 700 that can be used to obtain error log information from a test management system, including converting the log data from a JSON format to a relational format. Turning first to FIG. 7A, code portion 704 defines a set of filter conditions used to extract relevant logs from a test management system. The filter conditions can correspond to all or a portion of one or more test plans, or components thereof.

Code portion 708 connects to the test management system and requests data satisfying the filter conditions. Code line 710 defines a SQL statement for inserting extracted data into a database table. For example, the database table can be stored in association with the test analysis framework.

Turning to FIG. 7B, code portion 714 uses various JSON objects to store data received from a test management system, and to manipulate the data into a form that is more easily inserted into relational database tables. In particular, jsonObject can hold initial log results from a test management system. jsonObject1 can be used to hold individual log entries extracted from jsonObject. jsonObject2 stores the log entries of jsonObject1 as an array, including specific, selected JSON elements. That is, jsonObject2 can be a subset of information for individual log entries in jsonObject1. The definitions of the loops 720, 722 of FIG. 7A result in JSON objects, and corresponding SQL commands, being generated for specific logs meeting specific filter criteria. Code portion 728 of FIG. 7B writes a failure reason to an instance of jsonObject2, if a failure reason is present, or writes a null value otherwise.

### Example 7

### Example Retrieval and Display of Test Results

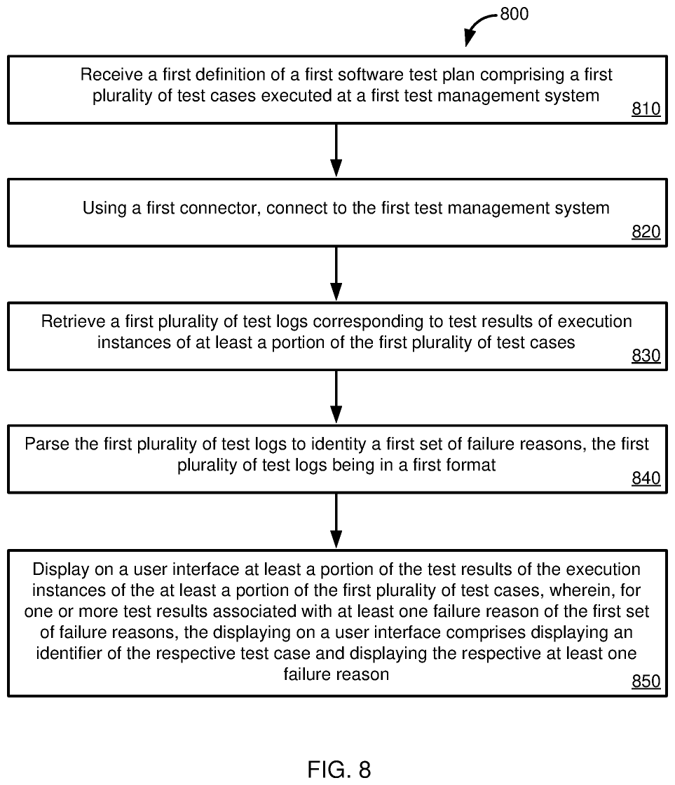

FIG. 8 provides a flowchart of a process 800 for retrieving and displaying test results. The process 800 can be performed in the computing environment 100 of FIG. 1. A first definition is received at 810 of a first software test plan that includes a first plurality of test cases executed at a first test management system. Using a first connector, a connection is made to the first test management system at 820. A first plurality of test logs are retrieved at 830, corresponding to test results of execution instances of at least a portion of the first plurality of test cases. At 840, the first plurality of test logs are parsed to identity a first set of failure reasons, the first plurality of test logs being in a first format.

At least a portion of the test results of the execution instances of the at least a portion of the first plurality of test cases are displayed on a user interface at 850. For one or more test results associated with at least one failure reason of the first set of failure reasons, the displaying on a user interface includes displaying an identifier of a respective test case and displaying a respective at least one failure reason.

### Example 8

### Computing Systems

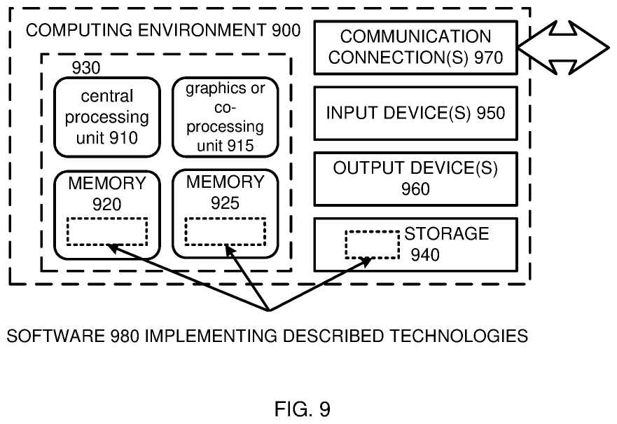

FIG. 9 depicts a generalized example of a suitable computing system 900 in which the described innovations may be implemented. The computing system 900 is not intended to suggest any limitation as to scope of use or functionality of the present disclosure, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing a database environment, and associated methods, described in Examples 1-7. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way, and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. The output device(s) 960 may be a display, printer, speaker, CD-writer, or another device that provides output from the computing system 900.

The communication connection(s) 970 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9

### Cloud Computing Environment

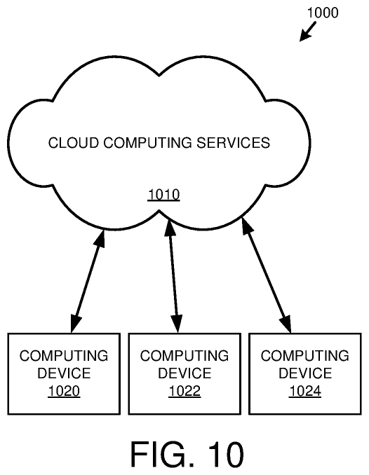

FIG. 10 depicts an example cloud computing environment 1000 in which the described technologies can be implemented. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operators (e.g., data processing, data storage, and the like).

### Example 10

### Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 9, computer-readable storage media include memory 920 and 925, and storage 940. The term computer-readable storage media does not include signals and carrier waves. In addition, the term computer-readable storage media does not include communication connections (e.g., 970).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving a first definition of a first software test plan comprising a first plurality of test cases executed at a first test management system;
using a first connector, connecting to the first test management system;
retrieving a first plurality of test logs corresponding to test results of execution instances of at least a portion of the first plurality of test cases;
parsing the first plurality of test logs to identity a first set of failure reasons, the first plurality of test logs being in a first format; and
displaying on a user interface at least a portion of the test results of the execution instances of the at least a portion of the first plurality of test cases, wherein, for one or more test results associated with at least one failure reason of the first set of failure reasons, the displaying on a user interface comprises displaying an identifier of a respective test case and displaying a respective at least one failure reason.

2. The computing system of claim 1, the operations further comprising:
receiving a second definition of a second software test plan comprising a second plurality of test cases executed at a second test management system;
using a second connector, connecting to the second test management system, wherein the second connector is different than the first connector;
retrieving a second plurality of test logs corresponding to execution instances of at least a portion of the second plurality of test cases;
parsing the second plurality of test logs to identify a second set of failure reasons, wherein the second plurality of test logs are in a second format, the second format being different than the first format; and
displaying on a user interface at least a portion of the test results of the execution instances of the at least a portion of the first plurality of test cases, wherein, for one or more test results associated with at least one failure reason of the second set of failure reasons, the displaying on a user interface comprises displaying an identifier of the respective test case and displaying the respective at least one failure reason.

3. The computing system of claim 2, wherein parsing the first plurality of test logs uses a first set of one or more tokens and parsing the second plurality of test logs uses a second set of one or more tokens, at least a portion of the second set of one or more tokens being different than tokens in the first set of one or more tokens.

4. The computing system of claim 3, wherein the first set of one or more tokens and the second set of one or more tokens are used to identify test failure of a test associated with a test log.

5. The computing system of claim 3, wherein the first set of one or more tokens and the second set of one or more tokens are used to identify a test failure reason of a test associated with a test log.

6. The computing system of claim 1, the operations further comprising:
receiving through the user interface a request to reexecute a test associated with a test case of the first plurality of test cases; and
in response to the receiving the request, causing the test to be reexecuted.

7. The computing system of claim 1, the operations further comprising:
displaying log identifiers on the user interface for at least a portion of the one or more test results for logs comprising test results for respective tests results of the at least a portion of the one or more test results.

8. The computing system of claim 7, the operations further comprising:
receiving user input selecting a displayed log identifier; and
in response to the receiving user input selecting a displayed log identifier, causing a log corresponding to the displayed log identifier to be displayed.

9. The computing system of claim 1, wherein the first plurality of test logs comprises multiple logs for a plurality execution instances of a test case of the first plurality of test cases, the operations further comprising:
with the first connector, selecting a log of the multiple logs according to at least one selection criterion.

10. The computing system of claim 9, wherein the at least one selection criterion comprises selecting a log associated with a most recent execution of the test case.

11. The computing system of claim 9, wherein the at least one selection criterion comprises is not based on selecting a log associated with a most recent execution of the test case.

12. The computing system of claim 9, wherein the at least one selection criterion comprises selecting a log associated a test failure of the test case.

13. The computing system of claim 1, the operations further comprising:
through the user interface, receiving a selection of a task; and
through the user interface, receiving a selection of a test plan of a plurality of test plans associated with the task to provide a selected test plan, wherein the first plurality of test cases are associated with the selected test plan.

14. The computing system of claim 1, wherein the first connector comprises access credentials used to access the first plurality of test logs.

15. The computing system of claim 14, wherein the access credentials correspond to a superuser of the first test management system.

16. A method, implemented in a computing system comprising at least one hardware processor and at least one memory coupled to the at least one hardware processor, the method comprising:
receiving a first definition of a first software test plan comprising a first plurality of test cases executed at a first test management system;
using a first connector, connecting to the first test management system;
retrieving a first plurality of test logs corresponding to test results of execution instances of at least a portion of the first plurality of test cases;
parsing the first plurality of test logs to identity a first set of failure reasons, the first plurality of test logs being in a first format; and
displaying on a user interface at least a portion of the test results of the execution instances of the at least a portion of the first plurality of test cases, wherein, for one or more test results associated with at least one failure reason of the first set of failure reasons, the displaying on a user interface comprises displaying an identifier of a respective test case and displaying a respective at least one failure reason.

17. The method of claim 16, further comprising:
receiving a second definition of a second software test plan comprising a second plurality of test cases executed at a second test management system;
using a second connector, connecting to the second test management system, wherein the second connector is different than the first connector;
retrieving a second plurality of test logs corresponding to execution instances of at least a portion of the second plurality of test cases;
parsing the second plurality of test logs to identify a second set of failure reasons, wherein the second plurality of test logs are in a second format, the second format being different than the first format; and
displaying on a user interface at least a portion of the test results of the execution instances of the at least a portion of the first plurality of test cases, wherein, for one or more test results associated with at least one failure reason of the second set of failure reasons, the displaying on a user interface comprises displaying an identifier of a respective test case and displaying a respective at least one failure reason.

18. The method of claim 16, wherein the first connector comprises access credentials used to access the first plurality of test logs, the access credentials corresponding to a superuser of the first test management system.

19. One or more computer-readable storage media comprising:
computer-executable instructions that, when executed by a computing system comprising at least one hardware processor and at least one memory coupled to the at least on hardware processor, cause the computing system to receive a first definition of a first software test plan comprising a first plurality of test cases executed at a first test management system;
computer-executable instructions that, when executed by the computing system, cause the computing system to, using a first connector, connect to the first test management system;
computer-executable instructions that, when executed by the computing system, cause the computing system to retrieve a first plurality of test logs corresponding to test results of execution instances of at least a portion of the first plurality of test cases;
computer-executable instructions that, when executed by the computing system, cause the computing system to parse the first plurality of test logs to identity a first set of failure reasons, the first plurality of test logs being in a first format; and
computer-executable instructions that, when executed by the computing system, cause the computing system to display on a user interface at least a portion of the test results of the execution instances of the at least a portion of the first plurality of test cases, wherein, for one or more test results associated with at least one failure reason of the first set of failure reasons, the displaying on a user interface comprises displaying an identifier of a respective test case and displaying a respective at least one failure reason.

20. The one or more computer-readable storage media of claim 19, further comprising:
computer-executable instructions that, when executed by the computing system, cause the computing system to receive a second definition of a second software test plan comprising a second plurality of test cases executed at a second test management system;
computer-executable instructions that, when executed by the computing system, cause the computing system to using a second connector, connect to the second test management system, wherein the second connector is different than the first connector;
computer-executable instructions that, when executed by the computing system, cause the computing system to retrieve a second plurality of test logs corresponding to execution instances of at least a portion of the second plurality of test cases;
computer-executable instructions that, when executed by the computing system, cause the computing system to parse the second plurality of test logs to identify a second set of failure reasons, wherein the second plurality of test logs are in a second format, the second format being different than the first format; and
computer-executable instructions that, when executed by the computing system, cause the computing system to display on a user interface at least a portion of the test results of the execution instances of the at least a portion of the first plurality of test cases, wherein, for one or more test results associated with at least one failure reason of the second set of failure reasons, the displaying on a user interface comprises displaying an identifier of a respective test case and displaying a respective at least one failure reason.
